(19) United States
(12) Patent Application Publication
(10) Pub. No.: US 2024/0308866 A1
(43) Pub. Date: Sep. 19, 2024

(54) METHOD OF TRANSPORTING CARBON DIOXIDE

(71) Applicant: Furno Materials, Inc., Moutain View, CA (US)

(72) Inventor: Gurinder Nagra, Polo Alto, CA (US)

(21) Appl. No.: 18/571,169

(22) PCT Filed: Aug. 18, 2022
(86) PCT No.: PCT/US2022/040764

§ 371 Date: Dec. 15, 2023

Related U.S. Application Data
(60) Provisional application No. 63/212,529, filed on Jun. 18, 2021.
(60) Provisional application No. 63/274,509, filed on Nov. 1, 2021.

(51) Int. Cl. C01F 5/24; B01J 20/04; B01J 20/34; C01B 32/55

(52) U.S. Cl. CPC C01F 5/24; B01J 20/041; B01J 20/3433; B01J 20/3483; C01B 32/55; C01P 2004/61; C01P 2004/62; C01P 2004/64

(57) ABSTRACT

A method of transporting CO₂ includes combining gaseous CO₂ produced at a point of origin with a solid metal oxide salt and/or a solid metal hydroxide salt at the point of origin to form a solid metal carbonate salt that includes the CO₂ from the point of origin and the metal from the metal oxide salt or the metal from the metal hydroxide salt. The method includes transporting the solid metal carbonate salt from the point of origin to a destination. The method also includes calcining the solid metal carbonate salt at the destination to generate gascous CO₂ and to re-generate the solid metal oxide salt and/or the solid metal hydroxide salt.

### CROSS-REFERENCE TO RELATED APPLICATIONS

This application claims the benefit of priority to U.S. Provisional Patent Application Ser. No. 63/212,529 filed Jun. 18, 2021, and U.S. Provisional Patent Application Ser. No. 63/274,509 filed Nov. 1, 2021, the disclosure of each of which is incorporated herein in its entirety by reference.

### BACKGROUND

Typically, after capture of CO₂ from its point source or from direct air capture (DAC), a pure stream of CO₂ is compressed into a super critical fluid to a high pressure (e.g., ˜10 MPa). The increased density of the compressed CO₂ causes the material to behave like a fluid, take up less space, and thus enable more efficient transport. Transport of CO₂ as a supercritical fluid, however, is conventionally limited to transport via pipeline or transport via cryogenic trucks. Transport of CO₂ via pipeline is limited to regions where there is existing pipeline infrastructure. While pipelines networks can be set up, capital costs are large and often left to third parties to finance (e.g., governments). The cost of trucking CO₂ via cryogenic trucks, on the other hand, increases with increasing distance from the point source of emissions; thus, facilities closest to the point source serve as the most attractive options when transporting CO₂ as a supercritical fluid.

More efficient and more effective ways to store CO₂ produced from point sources are needed, whether the quantities produced are large or small. A method of transporting CO₂ to a storage site that does not require maintenance of temperature, pressure, or both, is needed. A method of transporting CO₂ is needed that does not require the deployment of capital-intensive CO₂ transportation infrastructure, and that can leverage existing CO₂ transportation infrastructure.

### SUMMARY OF THE INVENTION

Various aspects of the present invention provide a method of transporting CO₂. The method includes combining gaseous CO₂ produced at a point of origin with a solid metal oxide salt and/or a solid metal hydroxide salt at the point of origin to form a solid metal carbonate salt that includes the CO₂ from the point of origin and the metal from the metal oxide salt or the metal from the metal hydroxide salt. The method includes transporting the solid metal carbonate salt from the point of origin to a destination. The method also includes calcining the solid metal carbonate salt at the destination to generate gaseous CO₂ and to re-generate the solid metal oxide salt and/or the solid metal hydroxide salt.

Various aspects of the present invention provide a method of transporting CO₂. The method includes combining gaseous CO₂ produced at a point of origin with solid MgO and/or solid Mg(OH)₂ at the point of origin to form MgCO₃ that includes the CO₂ from the point of origin and the Mg from the solid MgO and/or solid Mg(OH)₂. The method includes transporting the solid MgCO₃ at least 1,000 miles (˜1609 km) from the point of origin to a destination. The method also includes calcining the solid MgCO₃ at the destination to generate gaseous CO₂ and to re-generate the solid MgO and/or solid Mg(OH)₂.

Various aspects of the method of the present invention provide an efficient and effective method for transportation of CO₂ using existing infrastructure from a point of origin to a destination such as an end-user or geologic storage site. In various aspects, the method of the present invention provides a less costly method of transporting CO₂ than conventional methods of transporting the carbon dioxide as a liquid. In various aspects of the present invention, the solid metal oxide and/or solid metal hydroxide salt used to form the metal carbonate salt can be recycled and transported back to the point of origin for reuse. In various aspects of the method of the present invention, the method can be efficiently used for small or large quantities of carbon dioxide.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Method of Transporting Carbon Dioxide.

Various aspects of the present invention provide a method of transporting carbon dioxide. The method includes combining gaseous CO₂ produced at a point of origin with a solid metal oxide salt and/or a solid metal hydroxide salt. The combining is performed at the point of origin (e.g., proximate the point of origin, such that the CO₂ is never liquified for transport prior to the combining). The combining forms a solid metal carbonate salt that includes the CO₂ from the point of origin and the metal from the metal oxide salt or the metal from the metal hydroxide salt. The method includes transporting the solid metal carbonate salt from the point of origin to a destination. The method also includes calcining the solid metal carbonate salt at the destination to generate gaseous CO₂ and to re-generate the solid metal oxide salt and/or the solid metal hydroxide salt.

The method can further include storing the metal carbonate salt at the destination for a time period. The method can further include direct use by an end-user, compressing the gaseous CO₂ generated at the destination to form solid and/or liquid CO₂ (e.g., for distribution to an end-user), and/or depositing the gaseous CO₂ generated at the destination into a geologic storage site.

The method can further include transporting the solid metal oxide salt and/or the solid metal hydroxide salt formed at the destination to the point of origin. The transporting can be any suitable transporting, such as transporting the metal carbonate salt on a train, boat, and/or a truck. The transporting can include transporting the metal carbonate salt at least 100 miles, or at least 1,000 miles. The method can further include repeating the method using the re-generated solid metal oxide salt and/or the regenerated solid metal hydroxide salt with the gaseous CO₂ produced at the point of origin to form the solid metal carbonate salt.

The solid metal oxide salt can be used to form the solid metal carbonate salt. The solid metal hydroxide salt can be used to form the solid metal carbonate salt. A combination of the solid metal oxide salt and the solid metal hydroxide salt can be used to form the solid metal carbonate salt.

The solid metal oxide salt and/or solid metal hydroxide salt used to form the solid metal carbonate salt can have any suitable particle size (i.e., largest dimension of the particle), such as 0.1 microns to 100 microns, or 10 microns to 100 microns, or less than or equal to 100 microns and greater than or equal to 0.1 microns, 0.5, 1, 2, 3, 4, 5, 6, 8, 10, 12, 14, 16, 18, 20, 25, 30, 35, 40, 45, 50, 60, 70, 80, or 90 microns. The particle average can be a number-average particle size. The solid metal oxide salt and/or solid metal hydroxide salt used to form the solid metal carbonate salt can have any suitable particle shape, such as spherical or irregular, and can be porous or non-porous.

The metal of the metal oxide salt and/or metal hydroxide salt can be any suitable metal. For example, the metal can be Li, Na, K, Mg, Ca, or a combination thereof. The solid metal oxide salt can be MgO. The solid metal hydroxide salt can be Mg(OH)₂.

The solid metal carbonate salt can be Li₂CO₃, Na₂CO₃, MgCO₃, CaCO₃, or a combination thereof. The solid metal carbonate salt can be MgCO₃. The solid metal carbonate salt can have any suitable particle size, such as a particle size of 0.1 microns to 10 mm, or less than or equal to 10 mm and greater than or equal to 0.1 microns, 0.5, 1, 2, 3, 4, 5, 6, 8, 10, 15, 20, 25, 50, 75, 100, 150, 200, 250, 500, 750 microns, 1 mm, 5 mm, or 9 mm.

Combining the gaseous CO₂ at the point of origin with the solid metal oxide salt and/or solid metal hydroxide salt to form the solid metal carbonate salt can include flowing the gaseous CO₂ produced at the point of origin past the solid metal oxide salt and/or the solid metal hydroxide salt. The combining can be performed in any suitable one or more reactors. The reaction can be exothermic. The reactor can be maintained at any suitable temperature, such as from 0° C. to 3000° C., 10° C. to 200°° C., 10° C. to 30° C., or less than or equal to 3000° C. and greater than or equal to 0° C., 2, 4, 6, 8, 10, 12, 14, 16, 18, 20, 21, 22, 23, 24, 26, 25, 27, 28, 29, 30, 35, 40, 50, 60, 70, 80, 90, 100, 120, 140, 160, 180, 200, 300, 400, 500, 600, 650, 700, 750, 800, 850, 900, 950, 1,000, 1,050, 1,100, 1,150, 1,200, 1,300, 1,400, 1,500, 1,600, 1,800, 2,000, 2,200, 2,400, 2,600, or 2,800° C. The reactor can be maintained at or near room temperature. The pressure of the reactor can be maintained at from atmospheric pressure to 10 MPa, or from 0.1 MPa to 10 MPa, or equal to or less than 10 MPa and greater than or equal to 0.1 MPa, 0.2, 0.3, 0.4, 0.5, 0.6, 0.7, 0.8, 0.9, 1, 1.5, 2, 2.5, 3, 4, 5, 6, 7, 8, or 9 MPa. A higher pressure can result in faster carbonation. In some aspects, the reaction to form the solid metal carbonate salt predominantly or only occurs at the surface of the particles of solid metal oxide salt or solid metal hydroxide salt (e.g., any exposed surface, such as includes within pores), leaving unreacted solid metal oxide salt and/or solid metal hydroxide salt at the core of the produced solid metal carbonate particles.

The calcining can include heating the solid metal carbonate salt to a temperature in the range of 600°° C. to 3000°° C., 600° C. to 1200° C., or less than or equal to 3000° C. and greater than or equal to 600° C., 650, 700, 750, 800, 850, 900, 950, 1,000, 1,050, 1,100, 1,150, 1,200, 1,300, 1,400, 1,500, 1,600, 1,800, 2,000, 2,200, 2,400, 2,600, or 2,800° C. The heating can be performed in any suitable apparatus, such as an electric furnace or an oxyfuel furnace. The heating can be performed in any suitable type of clinker burning apparatus. In various embodiments, the solid metal carbonate salt can be combined with other conventional cement starting materials (e.g., SiO₂, Al₂O₃, Fe₂O₃, SO₃, MgO, P₂O₅, or a combination thereof), and the calcining includes heating the mixture including the solid metal carbonate salt to form cement clinker. In other aspects, the solid metal carbonate is the predominant or only material that is placed into the calcining apparatus.

In various aspects, the present method utilizes a high purity CO₂ stream which is input into a reaction chamber at the capture site prior to transport and storage. The size of this input and chamber can vary depending on the scale of the point source. It can be modular or it can be large scale. As this is inputted into the chamber so too is fresh metal oxide or hydroxide mineral (e.g., MgO or Mg(OH)₂) at a particle size<10 to <100 micron. In this adsorption chamber the high purity CO₂ gas flows counter-currently with the mineral sorbent (a thin layer of MgO or Mg(OH)₂) to form a carbonate solid mineral (e.g., MgCO₃ (s)). The MgO or Mg(OH)₂ therefore acts as a solid sorbent which chemically binds the CO₂ into a solid form for the purposes of transport.

Any suitable reaction chamber can be used to bind CO₂ to MgO. The reaction chamber can be a single reaction chamber or multiple reaction chambers (e.g., in series or parallel). The reactor can generate heat given Mg(OH)₂ (brucite)+CO₂→MgCO₃ is exothermic.

The produced metal carbonate salt (e.g., MgCO₃ (s)) is then utilized as a carrier/vessel/package that aids in the transport of CO₂ to its utilization or storage site. Transport of a solid carbonate mineral enables the use of all existing infrastructure that is already available to transport minerals across the globe. This includes truck, freight, and barge. The latter two, freight and shipping are the most important, given they are a significantly cheaper modes of transport than truck (≤0.15/ton-mile), with freight at 0.05/ton-mile and barge at <0.01/ton mile.

Upon delivery of the carbonate to the final destination for utilization or storage, the carbonate can be calcined in a furnace by heating it to temperatures between 600° C. and 1200° C., to produce the metal oxide and CO₂. For the case of a magnesium carbonate, lower temperature calcination is preferable because it results in higher specific surface areas of resulting particles than higher temperature calcination. The pure stream of CO₂ can be utilized for storage or utilization while the while the MgO can be recycled back to the point source site for further transport.

Whether the calcination employs an electric furnace or an oxyfuel furnace can depend on local price factors of fuel and electricity and other factors. The furnace can have lining and refractory material that can withstand the temperatures required for calcination of the carbonate mineral. The method can utilize oxyfuel and oxyfuel combustion processes in furnaces such as kilns. These oxyfuel systems can be batch or continuous. They can be in a single stage or multiple stages. They can also use any carbon or hydrogen-based fuel source.

In various aspects, an oxy-fuel system for calcination uses pure oxygen in combination with a fuel source to produce heat by flame production (i.e., combustion). Oxygen is supplied by an oxidizing agent in concentrations of about 85% to about 99% or mored—with preference for oxygen concentrations (e.g., oxygen supply purity) as high as possible. In this system, high-purity oxygen is fed, along with the fuel source in stoichiometric proportions, into a burner in the furnace. The oxygen-fueled calcination furnace includes at least one burner. The oxygen and fuel are ignited to release the energy stored in the fuel. Any fuel source can be used, such as natural gas and oxygen.

Use of an oxy-fired kiln for calcination can provide benefits such as (A) improved fuel consumption: to produce an equivalent amount of power or heat, fuel can be reduced by up to 70 percent, about 60 percent, about 50 percent, from 50 percent to 75 percent, and greater and smaller amounts; (B) the resulting flue gas emissions are a pure stream of CO₂ and water, which can be easily separated and combines with the already existing pure CO₂ stream.

Alternatively, the use of an electric arc furnace for calcination can provide benefits such as 1) no additional emissions, ₂) the potential for the calcination to be powered by cheap renewable electricity and, ₃) 100% efficient heating.

U.S. provisional application No. 63/391,632, entitled “METHOD AND APPARATUS FOR SUPERADIABATIC COMBUSTION”, is hereby incorporated by reference in its entirety; in various aspects of the presently claimed invention the method and/or apparatus described in this application can be used to calcine the solid metal carbonate salt (e.g., CaCO₃ or MgCO₃) to produce the solid metal oxide salt (e.g., CaO or MgO) or the solid metal hydroxide salt (e.g., Ca(OH)₂ or Mg(OH)₂).

### EXAMPLES

Various aspects of the present invention can be better understood by reference to the following Examples which are offered by way of illustration. The present invention is not limited to the Examples given herein.

### Example 1

In a flow process for the transport of CO₂, a pure stream of CO₂ is available from an oxy-fired point source at ˜100 t/day. It is to be noted this is just a hypothetical quantity—it could vary from Mt to 10's of ton/day. The CO₂ is fed into a chamber where it flows counter-current to MgO which is also input into this tower. The condition in the tower a set to enhance the kinetics of the reaction and form magnesium carbonate. This is transported via the multiple different pathways available to us now, truck, freight and barge.

Upon transport to the desired located the carbonate can be calcined in an oxy-fired or electric furnace-depending on the local costs for electricity and fuel. The calcination process is done at temperatures between 600° C. and 1200° C. Lower temperature for higher reactivity material. This results in a pure stream of CO₂ and MgO. CO₂ is either utilized or stored, while MgO is re-cycled back to the point source of CO₂ where it again acts a sorbent vessel/carrier for transporting CO₂ across large distances.

### Example 2

A CO₂ transport system of the present inventions is operationally associated with the equipment of systems using a temperature driven oxyfuel combustion system such as that described in U.S. patent application publication no. 2022/0024818, the entire disclosure of which is incorporated herein by reference. This system uses an oxyfuel combustion method for the purpose of manufacturing cement. This system can be a furnace, e.g., a kiln, that has linings and refractory materials that withstand and operate flame temperatures greater than 1,900° C., greater than 2,000° C., greater than 2,500° C., greater than 2,800° C., from about 2,000°° C. to about 2,800° C., about 2,500° C., about 2,600° C., about 2,700° C., and about 2,800° C., as well as greater and lower temperatures, that are provided by methods utilizing the oxyfuel combustion process. Thus, these aspects of the present systems operate at temperature at least 500 C, 700 C, 900 C greater than conventional air-fuel combustion systems which have much lower adiabatic flame temperatures˜or <1900° C. These systems can operate with other fuel systems or combustion systems in addition to using just an oxyfuel system. Ultimately, both air-fueled and oxyfuel furnaces produce cement clinker of a similar composition that falls within the ASTM C150 Standards.

### Example 3

A CO₂ transport system of the present inventions may be used solely as a clearing house to transport CO₂ from producer to user and track carbon credits through a database that integrates with enterprise software of each business. This is similar to the modern-day shipping container business, in this case the oxide mineral is the container or vessel that enables the transport of CO₂ using existing infrastructure to an end site. This could also be monetized as a storage solution service, where we conduct transport and storage. This would be enable monetization of local carbon credits on top of a service fee from the emitter. The primary benefit to the producer is they do not have to pay a cost for carbon anymore given they are carbon neutral. Our package would enable a simple way to quantify CO₂ removed and stored, and enable us to track and defend the storage.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### EXEMPLARY ASPECTS

The following exemplary aspects are provided, the numbering of which is not to be construed as designating levels of importance:
Aspect 1 provides a method of transporting CO₂, the method comprising:
   combining gaseous CO₂ produced at a point of origin with a solid metal oxide salt and/or a solid metal hydroxide salt at the point of origin to form a solid metal carbonate salt that comprises the CO₂ from the point of origin and the metal from the metal oxide salt or the metal from the metal hydroxide salt;
   transporting the solid metal carbonate salt from the point of origin to a destination; and
   calcining the solid metal carbonate salt at the destination to generate gaseous CO₂ and to re-generate the solid metal oxide salt and/or the solid metal hydroxide salt.
Aspect 2 provides the method of Aspect 1, further comprising compressing the gaseous CO₂ generated at the destination to form solid and/or liquid CO₂.
Aspect 3 provides the method of any one of Aspects 1-2, further comprising transporting the solid metal oxide salt and/or the solid metal hydroxide salt formed at the destination to the point of origin.
Aspect 4 provides the method of Aspect 3, further comprising repeating the method using the re-generated solid metal oxide salt and/or the regenerated solid metal hydroxide salt with the gaseous CO₂ produced at the point of origin to form the solid metal carbonate salt.
Aspect 5 provides the method of any one of Aspects 1-4, wherein transporting the solid metal carbonate salt from the point of origin to the destination comprises transporting the metal carbonate salt on a train, boat, and/or a truck.
Aspect 6 provides the method of any one of Aspects 1-5, wherein transporting the solid metal carbonate salt from the point of origin to the destination comprises transporting the metal carbonate salt at least 100 miles.
Aspect 7 provides the method of any one of Aspects 1-6, wherein transporting the solid metal carbonate salt from the point of origin to the destination comprises transporting the metal carbonate salt at least 1,000 miles.
Aspect 8 provides the method of any one of Aspects 1-7, wherein the solid metal oxide salt is used to form the solid metal carbonate salt.
Aspect 9 provides the method of any one of Aspects 1-8, wherein the solid metal oxide salt and/or solid metal hydroxide salt used to form the solid metal carbonate salt has a particle size of 0.1 microns to 100 microns.
Aspect 10 provides the method of any one of Aspects 1-9, wherein the solid metal oxide salt and/or solid metal hydroxide salt used to form the solid metal carbonate salt has a particle size of 10 microns to 100 microns.
Aspect 11 provides the method of any one of Aspects 1-10, wherein the metal of the metal oxide salt and/or metal hydroxide salt is Li, Na, K, Mg, Ca, or a combination thereof.
Aspect 12 provides the method of Aspect 1, wherein the solid metal oxide salt is used to form the solid metal carbonate salt, wherein the solid metal oxide salt is MgO.
Aspect 13 provides the method of any one of Aspects 1-12, wherein the solid metal hydroxide salt is used to form the solid metal carbonate salt.
Aspect 14 provides the method of Aspect 13, wherein the solid metal hydroxide salt is Mg(OH)₂.
Aspect 15 provides the method of any one of Aspects 1-14, wherein the solid metal carbonate salt is Li₂CO₃, Na₂CO₃, MgCO₃, CaCO₃, or a combination thereof.
Aspect 16 provides the method of any one of Aspects 1-15, wherein the solid metal carbonate salt is MgCO₃.
Aspect 17 provides the method of any one of Aspects 1-16, wherein the solid metal carbonate salt has a particle size in the range of 0.1 microns to 10 mm.
Aspect 18 provides the method of any one of Aspects 1-17, wherein combining the gaseous CO₂ at the point of origin with the solid metal oxide salt and/or solid metal hydroxide salt to form the solid metal carbonate salt comprises flowing the gaseous CO₂ produced at the point of origin past the solid metal oxide salt and/or the solid metal hydroxide salt.
Aspect 19 provides the method of any one of Aspects 1-18, wherein the calcining comprises heating the solid metal carbonate salt to a temperature in the range of 600° C. to 3000° C.
Aspect 20 provides the method of any one of Aspects 1-19, wherein the calcining comprises heating the solid metal carbonate salt to a temperature in the range of 600° C. to 1200° C.
Aspect 21 provides the method of any one of Aspects 1-20, wherein the calcining comprises heating the solid metal carbonate salt in and electric furnace or an oxyfuel furnace.
Aspect 22 provides a method of transporting CO₂, the method comprising:
   combining gaseous CO₂ produced at a point of origin with solid MgO and/or solid Mg(OH)₂ at the point of origin to form MgCO₃ that comprises the CO₂ from the point of origin and the Mg from the solid MgO and/or solid Mg(OH)₂;
   transporting the solid MgCO₃ at least 1,000 miles (˜1609 km) from the point of origin to a destination; and
   calcining the solid MgCO₃ at the destination to generate gaseous CO₂ and to re-generate the solid MgO and/or solid Mg(OH)₂.
Aspect 23 provides the method of any one or any combination of Aspects 1-22 optionally configured such that all elements or options recited are available to use or select from.

What is claimed is:

1. A method of transporting CO₂, the method comprising:
combining gaseous CO₂ produced at a point of origin with a solid metal oxide salt and/or a solid metal hydroxide salt at the point of origin to form a solid metal carbonate salt that comprises the CO₂ from the point of origin and the metal from the metal oxide salt or the metal from the metal hydroxide salt;
transporting the solid metal carbonate salt from the point of origin to a destination; and
calcining the solid metal carbonate salt at the destination to generate gaseous CO₂ and to re-generate the solid metal oxide salt and/or the solid metal hydroxide salt.

2. The method of claim 1, further comprising compressing the gaseous CO₂ generated at the destination to form solid and/or liquid CO₂.

3. The method of claim 1, further comprising transporting the solid metal oxide salt and/or the solid metal hydroxide salt formed at the destination to the point of origin.

4. The method of claim 3, further comprising repeating the method using the re-generated solid metal oxide salt and/or the regenerated solid metal hydroxide salt with the gaseous CO₂ produced at the point of origin to form the solid metal carbonate salt.

5. The method of claim 1, wherein transporting the solid metal carbonate salt from the point of origin to the destination comprises transporting the metal carbonate salt on a train, boat, and/or a truck.

6. The method of claim 1, wherein transporting the solid metal carbonate salt from the point of origin to the destination comprises transporting the metal carbonate salt at least 100 miles.

7. The method of claim 1, wherein transporting the solid metal carbonate salt from the point of origin to the destination comprises transporting the metal carbonate salt at least 1,000 miles.

8. The method of claim 1, wherein the solid metal oxide salt is used to form the solid metal carbonate salt.

9. The method of claim 1, wherein the solid metal oxide salt and/or solid metal hydroxide salt used to form the solid metal carbonate salt has a particle size of 0.1 microns to 100 microns.

10. The method of claim 1, wherein the solid metal oxide salt and/or solid metal hydroxide salt used to form the solid metal carbonate salt has a particle size of 10 microns to 100 microns.

11. The method of claim 1, wherein the metal of the metal oxide salt and/or metal hydroxide salt is Li, Na, K, Mg, Ca, or a combination thereof.

12. The method of claim 1, wherein the solid metal oxide salt is used to form the solid metal carbonate salt, wherein the solid metal oxide salt is MgO.

13. The method of claim 1, wherein the solid metal hydroxide salt is used to form the solid metal carbonate salt, wherein the solid metal hydroxide salt is Mg(OH)₂.

14. The method of claim 1, wherein the solid metal carbonate salt is Li₂CO₃, Na₂CO₃, MgCO₃, CaCO₃, or a combination thereof.

15. The method of claim 1, wherein the solid metal carbonate salt is MgCO₃.

16. The method of claim 1, wherein the solid metal carbonate salt has a particle size in the range of 0.1 microns to 10 mm.

17. The method of claim 1, wherein combining the gaseous CO₂ at the point of origin with the solid metal oxide salt and/or solid metal hydroxide salt to form the solid metal carbonate salt comprises flowing the gaseous CO₂ produced at the point of origin past the solid metal oxide salt and/or the solid metal hydroxide salt.

18. The method of claim 1, wherein the calcining comprises heating the solid metal carbonate salt to a temperature in the range of 600°° C. to 1200° C.

19. The method of claim 1, wherein the calcining comprises heating the solid metal carbonate salt in and electric furnace or an oxyfuel furnace.

20. A method of transporting CO₂, the method comprising:
combining gaseous CO₂ produced at a point of origin with solid MgO and/or solid Mg(OH)₂ at the point of origin to form MgCO₃ that comprises the CO₂ from the point of origin and the Mg from the solid MgO and/or solid Mg(OH)₂;
transporting the solid MgCO₃ at least 1,000 miles (˜1609 km) from the point of origin to a destination; and
calcining the solid MgCO₃ at the destination to generate gaseous CO₂ and to re-generate the solid MgO and/or solid Mg(OH)₂.
